(19) United States
(12) Patent Application Publication
(10) Pub. No.: US 2018/0070349 A1
(43) Pub. Date: Mar. 8, 2018

(54) SENSING AND DEFERRAL FOR ORTHOGONAL FREQUENCY DIVISIONAL MULTIPLE ACCESS IN A WIRELESS NETWORK

(71) Applicant: Intel IP Corporation, Santa Clara, CA (US)

(72) Inventors: Po-Kai Huang, San Jose, CA (US); Shahrnaz Azizi, Cupertino, CA (US); Thomas J. Kenney, Portland, OR (US); Chittabrata Ghosh, Fremont, CA (US); Robert J. Stacey, Portland, OR (US)

(21) Appl. No.: 15/549,071

(22) PCT Filed: Mar. 3, 2016
(86) PCT No.: PCT/US2016/020638

§ 371 Date: Aug. 4, 2017

Related U.S. Application Data
(60) Provisional application No. 62/127,997, filed on Mar. 4, 2015.

(51) Int. Cl. H04W 72/04; H04L 5/00; H04L 29/06

(52) U.S. Cl. CPC H04W 72/048; H04L 5/0037; H04W 84/12; H04L 69/18; H04L 5/0053

(57) ABSTRACT

Apparatus, computer readable medium, and method for sensing and deferral for orthogonal frequency division multiple access in a wireless local-area networks are disclosed. An apparatus of an access point is disclosed. The apparatus comprising memory and processing circuitry coupled to the memory. The processing circuitry may configured to configure the access point to sense a plurality of channels of a bandwidth, and determine a resource allocation for one or more stations for an uplink (UL) orthogonal frequency division multiple access (OFDMA) transmission opportunity. The resource allocation may include one or more channels of the plurality of channels that are sensed as not being busy. The processing circuitry may be further configured to encode a trigger frame comprising the resource allocation to initiate the UL OFDMA transmission opportunity and configure the access point to transmit the trigger fame to the one or more stations.

### PRIORITY CLAIM

This application claims the benefit of priority under to United States Provisional Patent Application Ser. No. 62/127,997, filed Mar. 4, 2015, which is incorporated herein by reference in its entirety.

### TECHNICAL FIELD

Embodiments pertain to wireless networks and wireless communications. Some embodiments relate to wireless local area networks (WLANs) including networks operating in accordance with the Institute of Electronic and Electrical Engineers (IEEE) 802.11 family of standards. Some embodiments relate to IEEE 802.11ax. Some embodiments relate to computer readable media, apparatuses, and methods for sensing and deferral for orthogonal frequency division multiple access (OFDMA) in wireless networks. Some embodiments relate to downlink (DL) and/or uplink (UL) transmission opportunities.

### BACKGROUND

Efficient use of the resources of a WLAN is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a WLAN in accordance with some embodiments:

FIG. 2 illustrates an access point determining a larger channel is busy based on a transmission on a part of the channel in accordance with some embodiments;

FIG. 3 illustrates interference from a station on a portion of a bandwidth in accordance with some embodiments;

FIG. 4 illustrates a method for sensing and sending DL data in accordance with some embodiments;

FIG. 5 illustrates a method for sensing and UL data in accordance with some embodiments;

FIG. 6 illustrates a method for polling for feedback (FB) in accordance with some embodiments;

FIG. 7 illustrates a method for station sensing in accordance with some embodiments;

FIG. 8 illustrates a method for sensing and deferral for OFDMA in accordance with some embodiments;

FIG. 9 illustrates a method for station sensing in accordance with some embodiments; and

FIG. 10 illustrates a block diagram of an example machine upon which any one or more of the techniques (e.g., methodologies) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

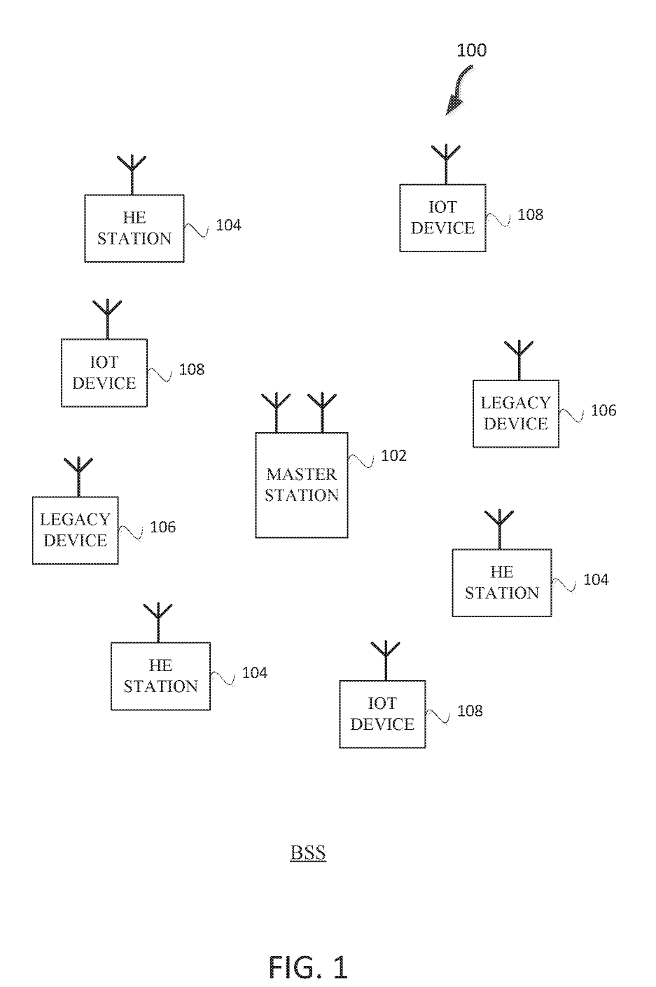

FIG. 1 illustrates a WLAN in accordance with some embodiments. The WLAN may comprise a basis service set (BSS) 100 that may include a master station 102, which may be an AP, a plurality of (e.g., IEEE 802.11) high-efficiency (HE) stations 104, a plurality of IoT device 108, and a plurality of legacy (e.g., IEEE 802.11) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO).

The legacy devices 106 may operate in accordance with one or more of IEEE 802.11 a/b/g/n/ac/ad/af/ah/aj, or another legacy wireless communication standard. The legacy devices 106 may be STAs or IEEE STAs. The STAs 104 may be wireless transmit and receive devices such as cellular telephone, smart telephone, handheld wireless device, wireless glasses, wireless watch, wireless personal device, tablet, or another device that may be transmitting and receiving using the IEEE 802.11 protocol such as IEEE 802.11ax or another wireless protocol.

The master station 102 may communicate with legacy devices 106. HE stations 104, and IoT device 108 in accordance with legacy IEEE 802.11 communication techniques. The HE stations 104 may be a newer (chronologically) version of an IEEE standard than the legacy device 104.

In some embodiments, a frame may be configurable to have the same bandwidth as a subchannel. The bandwidth of a subchannel may be 20 MHz. 40 MHz, or 80 MHz, 160 MHz. 320 MHz contiguous bandwidths or an 80+80 MHz (160 MHz) non-contiguous bandwidth. In some embodiments, the bandwidth of a subchannel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the subchannels may be based on a number of active subcarriers. In some embodiments the bandwidth of the subchannels are multiples of 26 (e.g., 26, 52, 104, etc.) active subcarriers or tones that are spaced by 20 MHz. In some embodiments the bandwidth of the subchannels is 256 tones spaced by 20 MHz. In some embodiments the subchannels are multiple of 26 tones or a multiple of 20 MHz. In some embodiments a 20 MHz subchannel may comprise 256 tones for a 256 point Fast Fourier Transform (FFT).

A HE frame may be configured for transmitting a number of spatial streams, which may be in accordance with MU-MIMO. In other embodiments, the master station 102, HE station 104, and/or legacy device 106 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, IoT related technologies, or other technologies.

The HE station 104 may be configured with applications that may be retrieved from remote servers (not illustrated). The IoT devices 108 may be simple devices. The IoT devices 108 may be low power devices. The IoT devices 108 may not include an interface for a user to access some functions that are settable of the IoT devices 108. The IoT device 108 may be low cost devices for controlling operations in a residential or business setting. In some embodiments the IoT devices 108 may be environmental reporting devices such as security devices and temperature devices.

The IoT devices 108 may include representations of information such as universal product codes (UPC), radio-frequency identification (RFID) tags, quick response (QR) codes, near-field communication (NFC), or any other suitable codes. The information may include an identification of the IoT device 108 and may include information regarding the capabilities of the IoT device 108. Examples of IoT devices 108 include sensors like a door sensor, a smart light bulb, a thermometer sensor, a television controller or sensor, a home automation camera and/or microphone, etc. The IoT devices 108 may be configured with an initial configuration at manufacturing time. In some embodiments, the IoT devices 108 may be securely connected to the master station 102 and/or HE station 104 using the transmitter of the IoT device 108 so that a different form of configuration such as UPC, RFIF, QR, or NFC is may not be needed. The IoT device 108 may include embedded security parameters. In some embodiments, a user cannot interact with the IoT devices 108 manually to configure the IoT devices 108.

In some embodiments, the HE stations 104 may act as sensor hubs. In some embodiments the master station 102 may act as an access gateway. The master station 102 may be in communication with the Internet and one or more devices such as an access service, which may store a master password.

The HE station 104 may include one or more mobile device applications (apps). The mobile device apps may be downloaded from an external server (not illustrated) or preloaded on the HE station 104. The mobile device apps may have their own security that is in addition to the security of the HE stations 104.

Some embodiments relate to HE communications. In accordance with some IEEE 802.11ax embodiments, a master station 102 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 102 may transmit a HE master-sync transmission, which may be a resource allocate element (e.g., a trigger frame for uplink or an HE SIG-B for downlink) or HE control and schedule transmission at the beginning of the HE control period. The schedule transmission may be for a short (current transmission) and/or a long term. The master station 102 may transmit a duration of the TXOP and sub-channel information. During the HE control period. HE STAs 104 may communicate with the master station 102 in accordance with a non-contention based simultaneous multiple access technique such as OFDMA or MU-MIMO. This is unlike conventional WLAN communications in which devices communicate in accordance with a contention-based communication technique, rather than a multiple access technique. During the HE control period, the master station 102 may communicate with one or more HE stations 104 using one or more HE frames. During the HE control period, the HE STAs 104 may operate on one or more sub-channels smaller than the operating range of the master station 102. During the HE control period, legacy stations refrain from communicating.

In accordance with some embodiments, during the master-sync transmission the HE STAs 104 may contend for the wireless medium with the legacy devices 106 being excluded from contending for the wireless medium during the master-sync transmission. In some embodiments the resource allocate element (for example trigger frame) may indicate an uplink (UL) UL-MU-MIMO and/or UL OFDMA control period.

In some embodiments, the simultaneous multiple-access technique used during the HE control period may be a scheduled OFDMA technique, although this is not a requirement. In some embodiments, the simultaneous multiple access technique may be a time-division multiple access (TDMA) technique or a frequency division multiple access (FDMA) technique. In some embodiments, the simultaneous multiple access technique may be a space-division multiple access (SDMA) technique.

The master station 102 may also communicate with legacy stations 106 and/or HE stations 104 in accordance with legacy IEEE 802.11 communication techniques. In some embodiments, the master station 102 may also be configurable to communicate with HE stations 104 outside the HE control period in accordance with legacy IEEE 802.11 communication techniques, although this is not a requirement.

In example embodiments, the HE stations 104, the master station 102, and/or IoT devices 108 are configured to perform the methods and functions herein described in conjunction with FIG. 1-xxx.

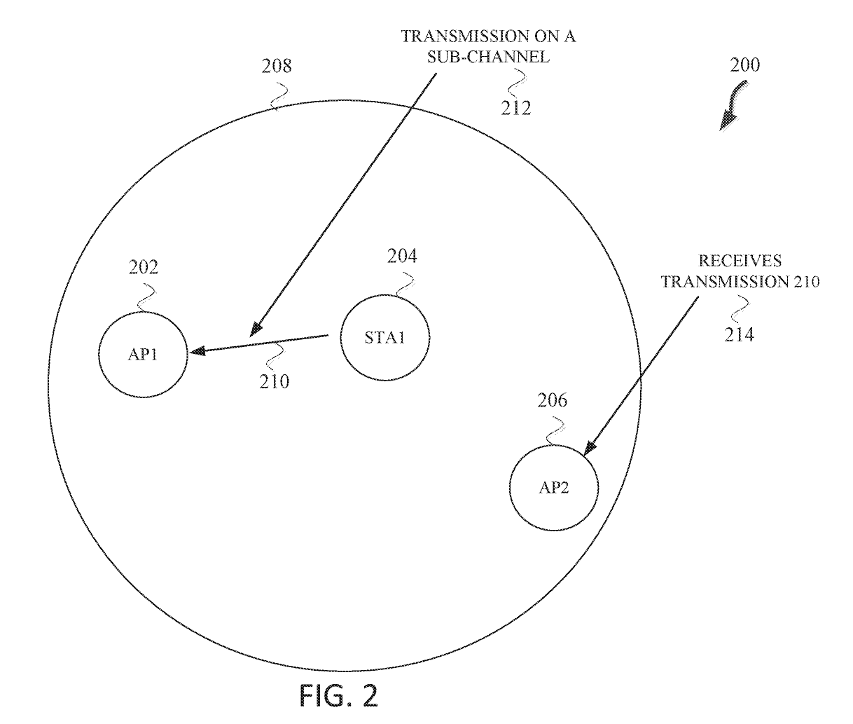

FIG. 2 illustrates an access point determining a larger channel is busy based on a transmission on a part of the channel in accordance with some embodiments. Illustrated in FIG. 2 is AP 202, STA1 204, AP2 206, and a transmission zone 208. AP1 202 and AP2 206 may be master stations 102. AP1 202 and AP2 206 may be configured to transmit in accordance with OFDMA and/or MU-MIMO. STA1 204 may be a HE station 104 or legacy station 108. The transmission zone 208 may indicate a transmission reach of transmission 210. Transmission 210 may be on a sub-channel. The sub-channel may have a bandwidth of 2.03 MHz or another bandwidth that is 20 MHz or less. In some embodiments the channel may be 80 MHz, 160 MHz, or 320 MHz. The AP2 206 receives transmission 210 at 214. AP2 206 may determine that a wider channel than the sub-channel of transmission 210 is busy. For example, in some embodiments, AP2 206 may receive transmission on a sub-channel 212 of 2.03 MHz and determine not to use a 20 MHz channel. As another example, AP2 206 may receive transmission on a sub-channel 212 of 20 MHz and determine not to use an 80 MHz channel.

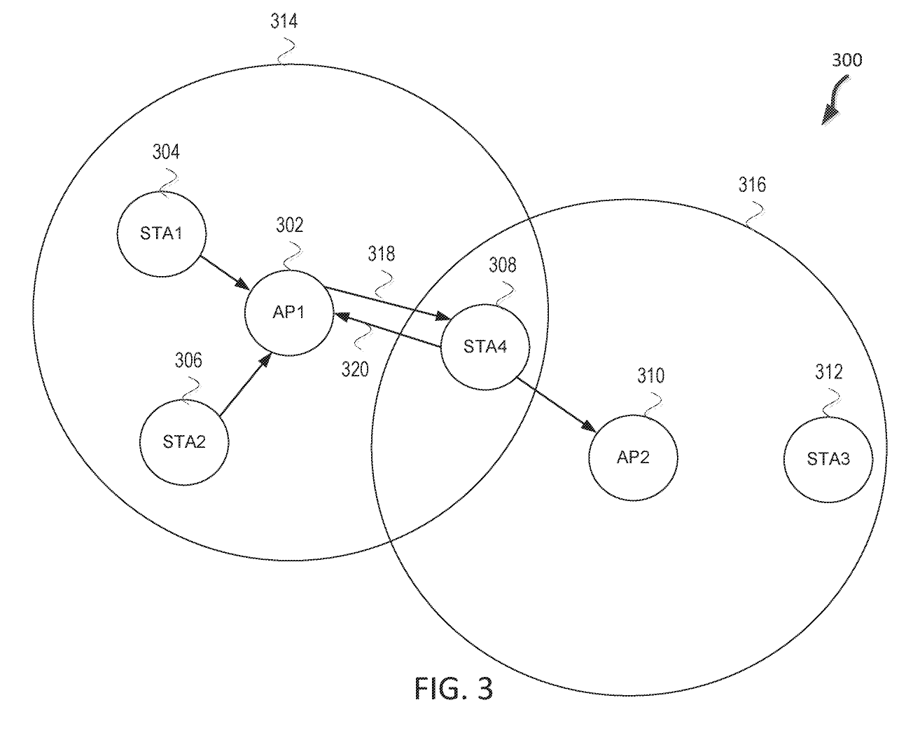

FIG. 3 illustrates interference from a station on a portion of a bandwidth in accordance with some embodiments. Illustrated in FIG. 3 is STA1 304, STA2 306, STA3 312, and STA4 308 each of which may be HE stations 104 and/or legacy stations 108. Also illustrated in FIG. 3 is AP1 302 and AP2 310 which may be master stations 102. Transmission zone 314 may indicate a transmission reach of AP1 302. Transmission zone 316 may indicate a transmission reach of AP2 310.

STA4 308 may be associated with AP2 310. Transmission 320 from STA4 308 may interfere with AP1 302 since STA4 308 is within the transmission zone 314. AP1 302 may receive transmission 320 from STA4 308 on a sub-channel (e.g., 2.03 MHz or 20 MHz) and not use a larger channel (e.g., 80 MHz) because of the reception of transmission 320 from STA4 308. For example, AP1 302 may defer until transmission 320 is over.

Moreover, STA4 308 may receive transmission 318 from AP1 302 and defer until transmission 318 is over. AP2 310 may not be aware that STA4 308 is deferring for transmission 318 from AP1 302, and may schedule STA4 308 for uplink transmissions in a transmission opportunity, which STA4 308 may not use because it is deferring for transmission 318 from AP1 302.

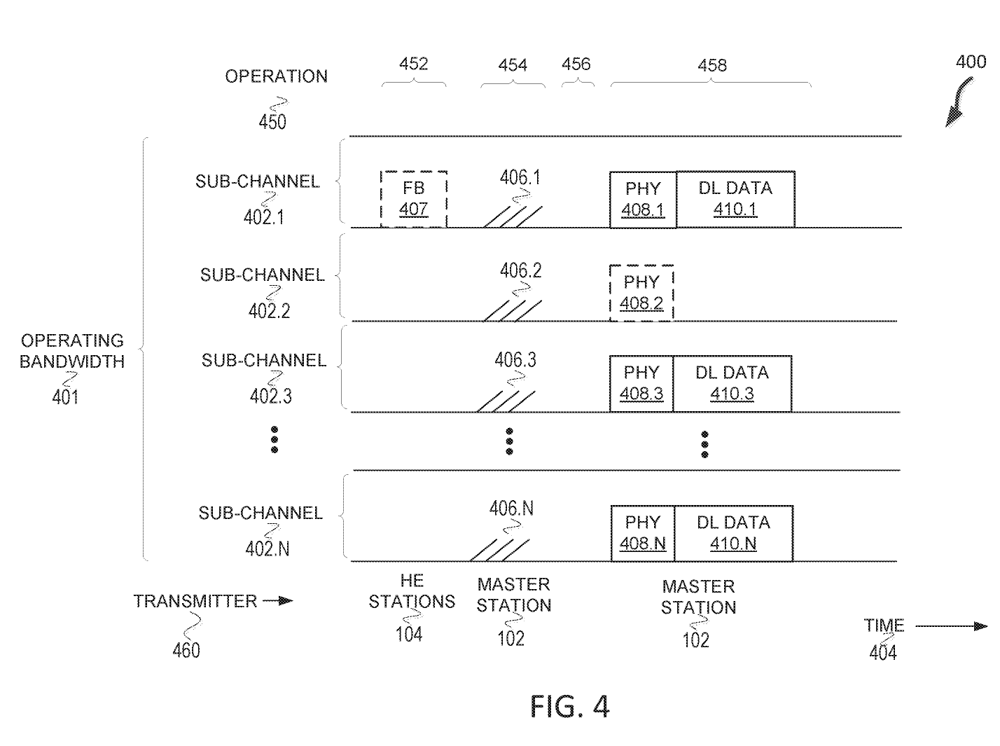

FIG. 4 illustrates a method for sensing and sending DL data in accordance with some embodiments. Illustrated in FIG. 4 is time 404 along a horizontal axis, sub-channels 402 along a vertical axis, operations 450 along the top, and a transmitter 460 along the bottom.

The sub-channels 402 may be a portion of a operating bandwidth 401. For example, the operating bandwidth 401 may be 80 MHz, and the sub-channels 402 may be 20 MHz sub-channels. In some embodiments, the operating bandwidth may be 20 MHz, 40 MHz, 80 MHz, 160 MHz, 320 MHz, or another suitable bandwidth. In some embodiments the sub-channels 402 may be 2.03 MHz, 4.06 MHz, a multiple of 2.03 MHz, 20 MHz, or another bandwidth less or equal to the operating bandwidth 401.

The method 400 may begin at operation 452 with one or more HE stations 104 transmitting feedback (FB) 407 to the master station 102. The FB 407 may be transmitted on a sub-channel 402.1 such as a primary channel or, in some embodiments, the FB 407 may be transmitted on separate channels as part of a transmission opportunity (see FIG. xxx). In some embodiments, the FB 407 is not transmitted to the master station 102.

The FB 407 may be based on one or more of the following. The FB 407 may be based on the HE stations 104 sensing an energy level on one or more of the sub-channels 402. The FB 407 may also be based on energy levels of neighboring sub-channels 402. The FB 407 may also be based on one or more network allocation vector (NAV) settings of the HE station 104. The FB 407 may be based on a signal to noise ratio (SNR) of received signals on the sub-channels 402 by the HE station 104. The FB 407 may be based on interference levels. In some embodiments, the FB 407 may be a requested sub-channel 402. In some embodiments the FB 407 may be sent to the master station 102 in another way. For example, the HE station 104 may transmit the FB 407 as part of another frame such as a buffer status frame. In some embodiments, there may be a field to indicate available sub-channel 402 in the FB 407, e.g. a bit for each sub-channel 402 to indicate whether the HE station 104 recommends that it can receive or transmit on this sub-channel 402.

The method 400 may continue at operation 454 with the master station 102 sensing 406 one or more of the sub-channels 402. For example, the master station 102 may measure an energy level on the sub-channels 402. The master station 102 may also measure interference on the sub-channels 402. In some embodiments, the sensing 506 may be performed sequentially rather than simultaneously as illustrated.

The method 400 may continue at operation 456 with the master station 102 determining a resource allocation (not illustrated) for HE stations 104 based on one or more of the following: the sensing 406, the FB 407, acknowledgments, negative acknowledgements, and other activity on the sub-channels 402. The resource allocation may be of sub-channels 402 that are smaller than the sensed sub-channels 402. For example, the sensed sub-channels 402 may be 20 MHz and the resource allocation may include sub-channels 402 of 2.03 MHz or a multiple of 2.03 MHz. The master station 102 may generate a resource allocation that indicates sub-channels 402 and durations for the downlink (DL) data 410.

The master station 102 may determine the resource allocation based on interference from adjacent sub-channels 402. In some embodiments, the master station 102 may add an analog filter design or a digital filter for receiving signals to mitigate interference from overlapping basic service set (OBSS) transmissions which may be on adjacent sub-channels 402 or on the sub-channel 402. In some embodiments, the master station 102 may determine not to use some sub-channels 402 based on the sensing 406 and/or FB 407. For example, as illustrated in FIG. 4, the master station 102 does not allocate sub-channel 402.2. In some embodiments, the master station 102 may allocate sub-channels 402 based on determining which sub-channels 402 are may be best for a HE station 104. In some embodiments, the master station 102 may determine the resource allocation based on previous sub-channel 402 behavior. For example, the master station 102 may have received negative acknowledgements and acknowledgements from the HE stations 104 and maintained a record of the negative acknowledgments and acknowledgments. In some embodiments, the master station 102 may maintain a record of other activity on the sub-channels 402 such as on which sub-channels 402 and for what duration the master station 102 has had to defer.

The method 400 may continue at operation 458 with the master station 102 transmitting the physical (PHY) 408 header(s) and DL data 410. The PHY 408 header(s) bandwidth may be the same bandwidth (2.03 or 20 MHz) as the DL data 410 or a bandwidth (e.g., 20, 40, 80, 160, or 320 MHz) that covers the operating bandwidth 401, in accordance with some embodiments. The PHY 408 header may include the resource allocation. In some embodiments, the HE stations 104 may add a digital filter design or an analog filter design to mitigate the interference from OBSS adjacent channels. The method 400 may continue with additional operations such as receiving acknowledgments (not illustrated) from the HE station 104. In some embodiments, operation 452 may be performed after operation 454.

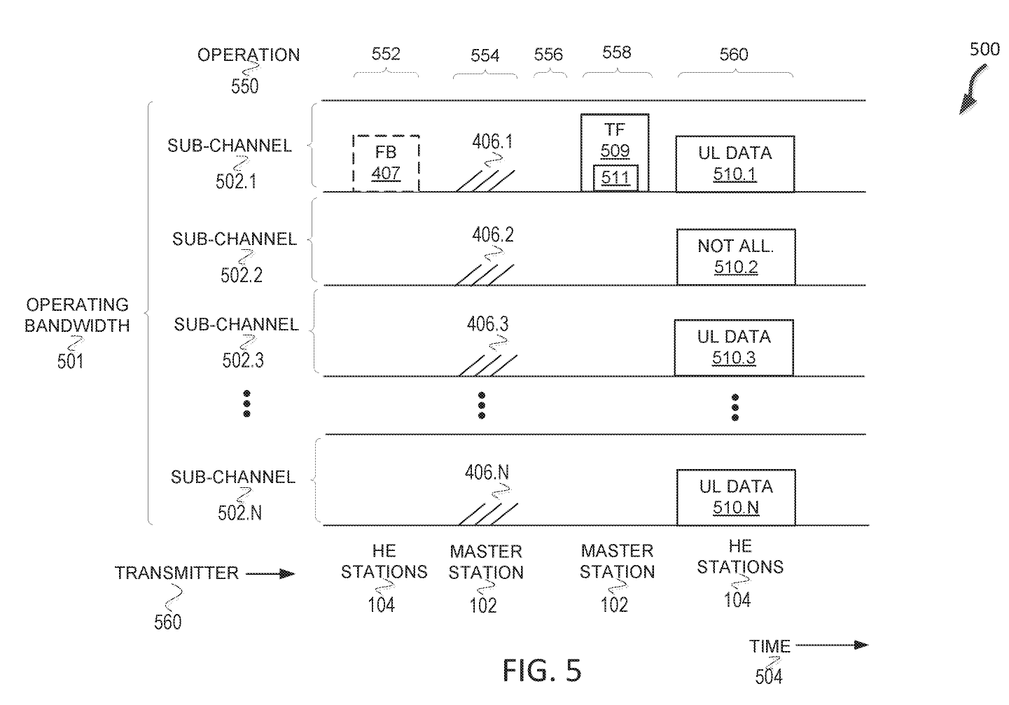

FIG. 5 illustrates a method for sensing and UL data in accordance with some embodiments. Illustrated in FIG. 5 is time 504 along a horizontal axis, sub-channels 502 along a vertical axis, operations 550 along the top, and a transmitter 560 along the bottom.

The sub-channels 502 may be a portion of an operating bandwidth 501. For example, the operating bandwidth 501 may be 80 MHz. and the sub-channels 402 may be 20 MHz sub-channels. In some embodiments, the operating bandwidth may be 20 MHz, 40 MHz. 80 MHz, 160 MHz, 320 MHz. or another suitable bandwidth. In some embodiments the sub-channels 402 may be 2.03 MHz, 4.06 MHz, a multiple of 2.03 MHz, 20 MHz, or another bandwidth less or equal to the operating bandwidth 501.

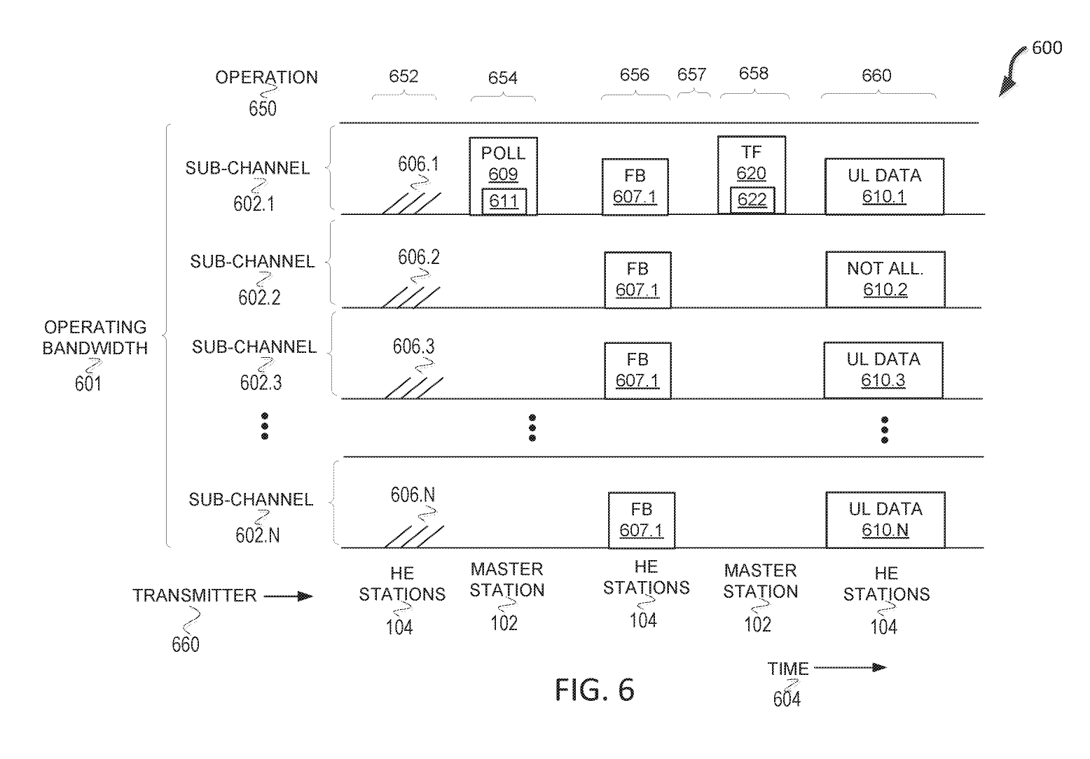

The method 500 may begin at operation 552 with one or more HE stations 104 transmitting feedback (FB) 407 to the master station 102. The FB 407 may be transmitted on a sub-channel 502.1 such as a primary channel or, in some embodiments, the FB 407 may be transmitted on separate channels as part of a transmission opportunity (see FIG. 6). In some embodiments, the FB 407 is not transmitted to the master station 102. The FB 407 may be the same or similar as disclosed in conjunction with FIG. 4.

The method 500 may continue at operation 554 with the master station 102 sensing 406 one or more of the sub-channels 502. The sensing 406 may be the same or similar as disclosed in conjunction with FIG. 4.

The method 500 may continue at operation 556 with the master station 102 determining a resource allocation 511 for HE stations 104 based on one or more of the following: the sensing 406, the FB 407, acknowledgments, negative acknowledgements, and other activity on the sub-channels 502. The master station 102 may generate a resource allocation 511 that indicates sub-channels 502, modulation and coding scheme (MCS), and durations for the UL data 510. The sub-channels 502 in the resource allocation 511 may be a different bandwidth than the sub-channels 502 of the sensing 454 or the FB 407. For example, the sub-channels 202 of the sensing 554 may be 20 MHz and some of the sub-channels 202 of the resource allocation 511 may be 2.03 MHz or a multiple of 2.03 MHz. The master station 102 may determine the resource allocation 511 based on interference from adjacent sub-channels 502. In some embodiments, the master station 102 may add an analog filter design or a digital filter for receiving signals to mitigate interference from overlapping basic service set (OBSS) transmissions which may be on adjacent sub-channels 502 or on the sub-channel 502.

In some embodiments, the master station 102 may determine not to use some sub-channels 502 based on the sensing 406 and/or FB 407. For example, as illustrated in FIG. 5, the master station 102 does not allocate sub-channel 502.2. In some embodiments, the master station 102 may allocate sub-channels 502 based on determining which sub-channels 502 may be best for a HE station 104. In some embodiments, the master station 102 may determine the resource allocation 511 based on previous sub-channel 502 behavior. For example, the master station 102 may have received negative acknowledgements and acknowledgements from the HE stations 104 and maintained a record of the negative acknowledgments and acknowledgments. In some embodiments, the master station 102 may maintain a record of other activity on the sub-channels 502 such as on which sub-channels 502 and for what duration the master station 102 has had to defer.

The method 500 may continue at operation 558 with the master station 102 transmitting the trigger frame (TF) 509. The TF 509 may comprise the resource allocation 511. In some embodiments, the TF 509 may be transmitted on a primary channel, which may be sub-channel 502.1.

The method 500 may continue at operation 560 with the HE stations 104 transmitting UL data 510. For example, HE station 104.1 may transmit UL data 510.1; HE station 104.2 may transmit UL data 510.3, and HE station 104.3 may transmit UL data 510.N. As illustrated sub-channel 502.2 was not included in the resource allocation 511. The method 500 may continue with additional operations (not illustrated). In some embodiments, operation 552 may be performed after operation 554.

FIG. 6 illustrates a method 600 for polling for feedback (FB) in accordance with some embodiments. Illustrated in FIG. 6 is time 604 along a horizontal axis, sub-channels 602 along a vertical axis, operations 650 along the top, and a transmitter 660 along the bottom.

The sub-channels 602 may be a portion of an operating bandwidth 601. For example, the operating bandwidth 601 may be 80 MHz, and the sub-channels 402 may be 20 MHz sub-channels. In some embodiments, the operating bandwidth may be 20 MHz, 40 MHz, 80 MHz, 160 MHz, 320 MHz, or another suitable bandwidth. In some embodiments the sub-channels 602 may be 2.03 MHz, 4.06 MHz, a multiple of 2.03 MHz, 20 MHz, or another bandwidth less or equal to the operating bandwidth 601.

The method 600 may begin at operation 652 with one or more HE stations 104 sensing 606 one or more of the sub-channels 602. For example, the HE stations 104 may measure an energy level on the sub-channels 602. The HE stations 104 may also measure interference on the sub-channels 602. In some embodiments, the sensing 606 may be performed sequentially rather than simultaneously as illustrated.

The method 600 may continue at operation 654 with the master station 102 transmitting a poll 609 frame with a resource allocation 611. The resource allocation 611 may indicate which HE station 104 are to transmit FB 607 and how to transmit the FB 607, e.g., a sub-channel 602, MCS, and duration. The poll 609 may be frame that indicates the master station 102 is requesting FB 607 from the HE stations 104.

The method 600 may continue at operation 656 with the HE stations 104 transmitting FB 607. In some embodiments, operation 652 is performed after the HE stations 104 receive the poll 609 frame. In some embodiments, the HE stations 104 may transmit the FB 607 sequentially based on one or more poll 609 frames.

The FB 607 may be based on one or more of the following. The FB 607 may be based on the HE stations 104 sensing an energy level on one or more of the sub-channels 602. The FB 607 may also be based on energy levels of neighboring sub-channels 602. The FB 607 may also be based on one or more network allocation vector (NAV) settings of the HE station 104. The FB 607 may be based on a signal to noise ratio (SNR) of received signals on the sub-channels 602 by the HE station 104. The FB 607 may be based on interference levels. In some embodiments, the FB 607 may be a requested sub-channel 602.

The method 600 may continue at operation 657 with the master station 102 determining a resource allocation 622 for HE stations 104 based on one or more of the following: the master station 102 sending (not illustrated), the FB 607, acknowledgments, negative acknowledgements, and other activity on the sub-channels 602. The resource allocation 622 may be of sub-channels 602 that are smaller than the sensed sub-channels 602 or sub-channels that may be in the FB 607. For example, the sensed sub-channels 602 may be 20 MHz and the resource allocation 622 may include sub-channels 602 of 2.03 MHz or a multiple of 2.03 MHz. The master station 102 may generate a resource allocation 622 that indicates sub-channels 602. MCS, and durations for the UL data 610.

The master station 102 may determine the resource allocation 622 based on interference from adjacent sub-channels 602. In some embodiments, the master station 102 may add an analog filter design or a digital filter for receiving signals to mitigate interference from overlapping basic service set (OBSS) transmissions which may be on adjacent sub-channels 602 or on the sub-channel 602. In some embodiments, the master station 102 may determine not to use some sub-channels 602 based on the sensing and/or FB 607. For example, as illustrated in FIG. 6, the master station 102 does not allocate sub-channel 602.2. In some embodiments, the master station 102 may allocate sub-channels 602 based on determining which sub-channels 602 are may be best for a HE station 104. In some embodiments, the master station 102 may determine the resource allocation 622 based on previous sub-channel 602 behavior. For example, the master station 102 may have received negative acknowledgements and acknowledgements from the HE stations 104 and maintained a record of the negative acknowledgments and acknowledgments. In some embodiments, the master station 102 may maintain a record of other activity on the sub-channels 602 such as on which sub-channels 602 and for what duration the master station 102 has had to defer.

The method 600 may continue at operation 658 with the master station 102 transmitting the trigger frame (TF) 620. The TF 620 may comprise the resource allocation 622. In some embodiments, the TF 620 may be transmitted on a primary channel, which may be sub-channel 602.1. In some embodiments, the master station 102 may be configured to sense the sub-channels 602 before generating the trigger frame 620 and to only use sub-channels 602 determined to be not busy by the master station 102.

The method 600 may continue at operation 660 with the HE stations 104 transmitting UL data 610. For example, HE station 104.1 may transmit UL data 610.1; HE station 104.2 may transmit UL data 610.3, and HE station 104.3 may transmit UL data 610.N. As illustrated sub-channel 602.2 was not included in the resource allocation 622. The method 600 may continue with additional operations (not illustrated).

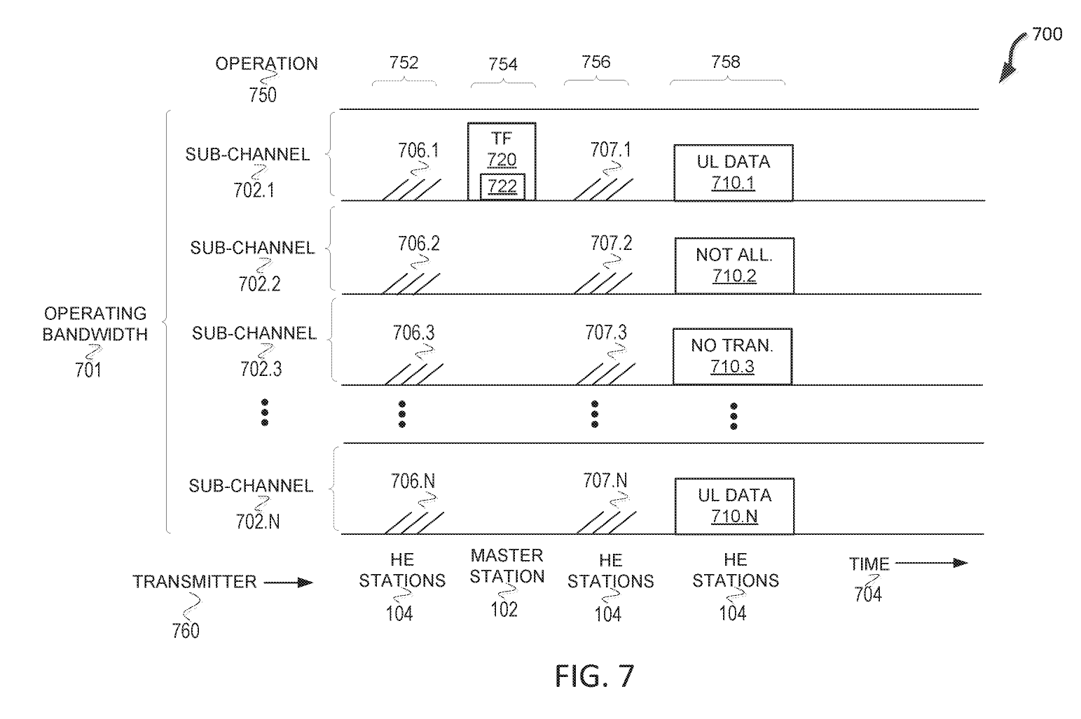

FIG. 7 illustrates a method 700 for station sensing in accordance with some embodiments. Illustrated in FIG. 7 is time 704 along a horizontal axis, sub-channels 702 along a vertical axis, operations 750 along the top, and a transmitter 760 along the bottom.

The sub-channels 702 may be a portion of an operating bandwidth 701. For example, the operating bandwidth 701 may be 80 MHz, and the sub-channels 702 may be 20 MHz sub-channels. In some embodiments, the operating bandwidth may be 20 MHz. 40 MHz, 80 MHz, 160 MHz, 320 MHz, or another suitable bandwidth. In some embodiments the sub-channels 702 may be 2.03 MHz, 4.06 MHz, a multiple of 2.03 MHz, 20 MHz, or another bandwidth less or equal to the operating bandwidth 701.

The method 700 may optionally begin at operation 752 with one or more HE stations 104 sensing 706 one or more of the sub-channels 702. For example, the HE stations 104 may measure an energy level on the sub-channels 702. The HE stations 104 may also measure interference on the sub-channels 702. In some embodiments, the sensing 706 may be performed sequentially rather than simultaneously as illustrated.

The method 700 may continue at operation 754 with the master station 102 transmitting the trigger frame (TF) 720. The TF 720 may comprise the resource allocation 722. In some embodiments, the TF 720 may be transmitted on a primary channel, which may be sub-channel 702.1. In some embodiments, the master station 102 may be configured to sense the sub-channels 702 before generating the trigger frame 620 and to only use sub-channels 702 determined to be not busy by the master station 102.

The method 700 may optionally continue at operation 756 with one or more HE stations 104 sensing 707 one or more of the sub-channels 702. For example, the HE stations 104 may measure an energy level on the sub-channels 702. The HE stations 104 may also measure interference on the sub-channels 702. In some embodiments, the sensing 706 may be performed sequentially rather than simultaneously as illustrated. The HE stations 104 may sense either before the TF 720 or after the TF 720 or both.

The method continues at operation 758 with the HE stations 104 transmitting UL data 710 in accordance with the resource allocation 722. The HE stations 104 may before transmitting the UL data 710 determine whether to transmit in accordance with the resource allocation 722. For example, as illustrated, a HE station 104 determined not to transmit on sub-channel 702.3 with no transmission 710.3, and master station 102 determined not to allocate sub-channel 702.2 with not allocated 710.2. As an example, a HE station 104 may receive a resource allocation 722 on a sub-channel 702 and based on the sensing at operation 752 and/or 756 determine whether to transmit on the allocated sub-channel 702 based on the energy level on the sub-channel 702. For example, if the energy level is above a threshold, then the HE station 104 may determine not to transmit. In some embodiments, the HE station 104 may base the determination of whether to transmit on a sub-channel 702 (e.g., sub-channel 702.3) based on sensing neighboring sub-channels (e.g., sub-channels 702.1 and sub-channel 702.4). For example, if an energy level of sub-channel 702.1 and/or sub-channel 702.4 is above a threshold, then the HE station 104 may determine not to transmit on sub-channel 702.2. The reason for the HE station 104 not to transmit is that the HE station 104 may know there is a close by HE station 104 performing OFDMA transmissions on the same sub-channel 702.2, which may be detected on neighboring sub-channels 702.1 and 702.3.

The sensing of operations 752 and 756 may be in accordance with CCA (ED) sensing and may be in accordance with parameters set by the master station 102. In some embodiments, the HE station 104 may not transmit on the sub-channel 702 unless the energy detect CCA is idle for a specific period of time such as Point Coordination Function (PCF) inter-frame space (PIFS). The HE station 104 may measure the before or after the TF 720. Moreover, the HE station 104 may determine not to transmit or to defer if a NAV of the HE station 104 is set.

If the resource allocation 722 indicates a wider channel than sensed 706 at operation 752 and/or 756, then the HE station 104 may combine the results of the senses 706. For example, the HE station 104 may sense 706 20 MHz sub-channels 702 and be allocated a 40 MHz sub-channel 702. The HE station 104 may also stop transmitting a UL data 710 if in the middle of transmitting the UL data 710 the HE station 104 determines the sub-channel 702 is busy.

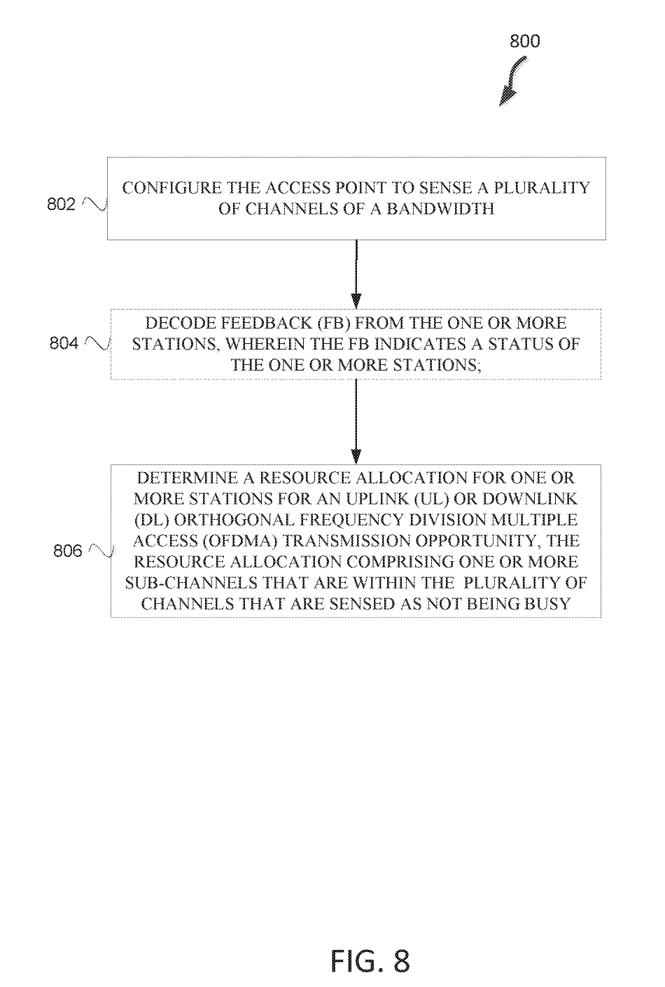

FIG. 8 illustrates a method 800 for sensing and deferral for OFDMA in accordance with some embodiments. The method 800 may begin at operation 802 with configuring the access point to sense a plurality of channels of a bandwidth. For example, the master station 102 may be configured to sense the sub-channels 402, 502 at operations 454, 554 as disclosed in conjunction with FIG. 4, FIG. 5, respectively. Moreover, the master station 102 may be configured to sense the sub-channels 602 prior to generating the TFs 620 as disclosed in conjunction with FIG. 6.

The method 800 may optionally continue at operation 804 with decoding FB from the one or more stations, the FB indicates a status of the one or more stations. For example, master station 102 may decode FB 407, 607 as disclosed in conjunction with FIG. 4 and FIG. 6, respectively. Operations 802 and 804 may be reversed in order.

The method 800 may continue at operation 806 with determining a resource allocation for one or more stations for an UL or DL OFDMA transmission opportunity, the resource allocation comprising one or more sub-channels, and the one or more sub-channels being within the plurality of channels that are sensed as not being busy. In the embodiments with operation 804 the master station 102 may determine the resource allocation further based on the feedback from the one or more stations. For example, the master station 102 determine the resource allocation before transmitting DL data 410 in FIG. 4 based on the FB 407 and/or sensing 406. As another example, the master station 102 determines TF 509 based on the FB 407 and/or the sensing 406. The master station 102 determines TF 620 based on FB 607 and optionally sensing of the sub-channels 602 (not illustrated) by the master station 102.

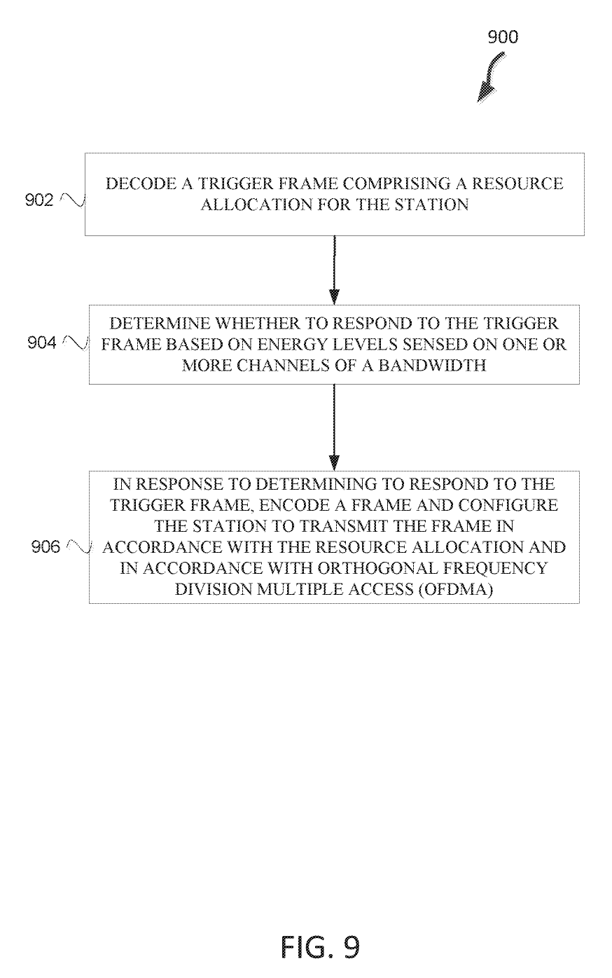

FIG. 9 illustrates a method 900 for station sensing in accordance with some embodiments. The method 900 begins at operation 902 with decoding a trigger frame comprising a resource allocation for the station. For example, the HE stations 104 may receive TF 720.

The method 900 continues at operation 904 with determining whether to respond to the trigger frame based on energy levels sensed on one or more channels of a bandwidth. For example, HE stations 104 may sense sub-channels 702 either before receiving the TF 720 or after receiving the TF 720 as disclosed in conjunction with FIG. 7. The order of operations 902 and 904 may be reversed.

The method 900 may continue at operation 906 with in response to determining to respond to the trigger frame, encoding a frame and configure the station to transmit the frame in accordance with the resource allocation and in accordance with OFDMA. For example, HE stations 104 determine whether to transmit UL data 710 or not based on the sensing 706 and/or sensing 707.

Some embodiments of the methods, computer readable media, and apparatuses disclosed for sensing and deferral for orthogonal frequency divisional multiple access in a wireless network may solve the problem of when and how to defer.

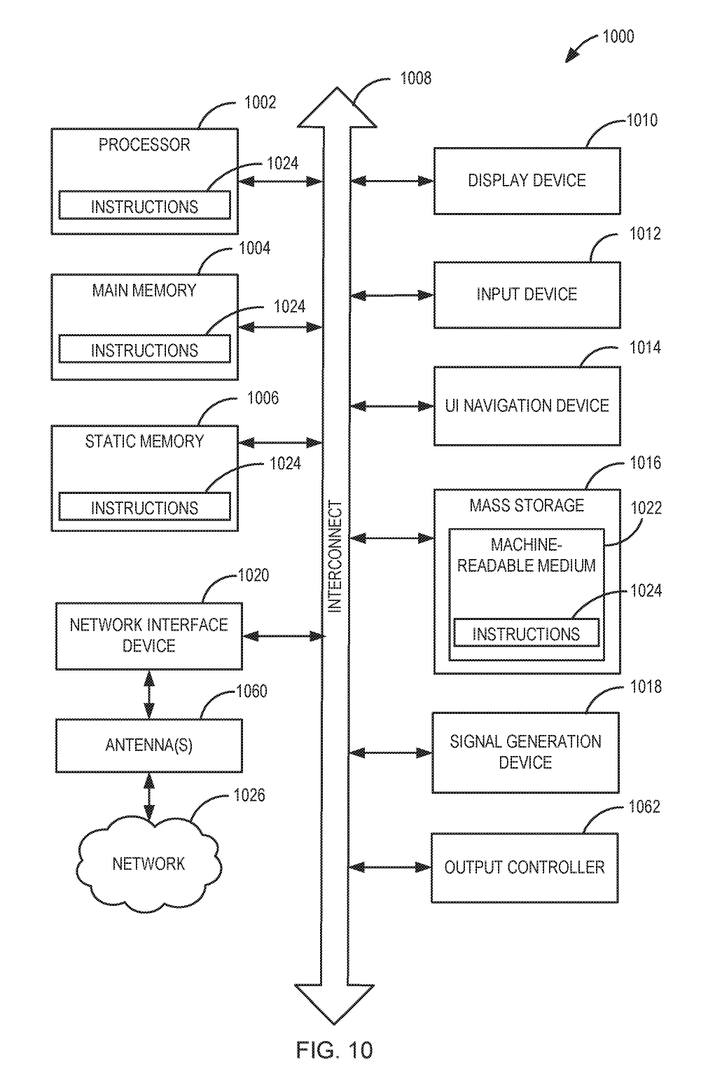

FIG. 10 illustrates a block diagram of an example machine 1000 upon which any one or more of the techniques (e.g., methodologies) discussed herein may perform. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in peer-to-peer (P2P) (or other distributed) network environment. The machine 1000 may be a master station 102, HE station 104, IoT device 108, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 1000 may include a hardware processor 1002 (e.g., a central processing unit (CPU), a graphics processing unit (GPU), a hardware processor core, or any combination thereof), a main memory 1004 and a static memory 1006, some or all of which may communicate with each other via an interlink (e.g., bus) 1008. The machine 1000 may further include a display unit 1010, an alphanumeric input device 1012 (e.g., a keyboard), and a user interface (UI) navigation device 1014 (e.g., a mouse). In an example, the display unit 1010, input device 1012 and UI navigation device 1014 may be a touch screen display. The machine 1000 may additionally include a storage device (e.g., drive unit) 1016, a signal generation device 1018 (e.g., a speaker), a network interface device 1020, and one or more sensors 1021, such as a global positioning system (GPS) sensor, compass, accelerometer, or other sensor. The machine 1000 may include an output controller 1028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 1002 and/or instructions 1024 may comprise processing circuitry.

The storage device 1016 may include a machine readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within static memory 1006, or within the hardware processor 1002 during execution thereof by the machine 1000. In an example, one or any combination of the hardware processor 1002, the main memory 1004, the static memory 1006, or the storage device 1016 may constitute machine readable media.

While the machine readable medium 1022 is illustrated as a single medium, the term “machine readable medium” may include a single medium or multiple media (e.g., a centralized or distributed database, and/or associated caches and servers) configured to store the one or more instructions 1024.

The term “machine readable medium” may include any medium that is capable of storing, encoding, or carrying instructions for execution by the machine 1000 and that cause the machine 1000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM). Electrically Erasable Programmable Read-Only Memory (EEPROM)) and flash memory devices, magnetic disks, such as internal hard disks and removable disks; magneto-optical disks; Random Access Memory (RAM); and CD-ROM and DVD-ROM disks. In some examples, machine readable media may include non-transitory machine readable media. In some examples, machine readable media may include machine readable media that is not a transitory propagating signal.

The instructions 1024 may further be transmitted or received over a communications network 1026 using a transmission medium via the network interface device 1020 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi, IEEE 802.16 family of standards known as WiMax), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 1020 may include one or more physical jacks (e.g., Ethernet, coaxial, or phone jacks) or one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. In some examples, the network interface device 1020 may wirelessly communicate using Multiple User MIMO techniques. The term “transmission medium” shall be taken to include any intangible medium that is capable of storing, encoding or carrying instructions for execution by the machine 1000, and includes digital or analog communications signals or other intangible medium to facilitate communication of such software.

The following examples pertain to further embodiments. Example 1 is an apparatus of an access point. The apparatus may include memory, and processing circuitry coupled to the memory, the processing circuitry may be configured to: configure the access point to sense a plurality of channels of a bandwidth; and determine a resource allocation for one or more stations for an uplink (UL) or downlink (DL) orthogonal frequency division multiple access (OFDMA) transmission opportunity, wherein the resource allocation comprises one or more sub-channels, wherein the one or more sub-channels are within the plurality of channels that are sensed as not being busy.

In Example 2, the subject matter of Example 1 can optionally include where the processing circuitry is further configured to: encode a trigger frame comprising the resource allocation to initiate the UL OFDMA transmission opportunity; and configure the access point to transmit the trigger frame to the one or more stations.

In Example 3, the subject matter of Examples 1 or 2 can optionally include where the one or more channels are 20 MHz channels and the bandwidth is one from the following group: 20 MHz, 40 MHz, 80 MHz, 160 MHz, and 320 MHz.

In Example 4, the subject matter of Example 3 can optionally include where the one or more sub-channels each are one from the following group: a multiple of 2.03 MHz, a multiple of exactly 26 data sub-carriers, and 20 MHz.

In Example 5, the subject matter of any of Examples 1-4 can optionally include where the processing circuitry is further configured to: configure the access point to sense the one or more channels of the bandwidth in accordance with a clear channel assessment in accordance with Institute of Electrical and Electronic Engineers (IEEE) 802.11.

In Example 6, the subject matter of Example 5 can optionally include where the processing circuitry is further configured to: configure the access point to sense the one or more channels of the bandwidth with a second bandwidth that is smaller than a third bandwidth of the one or more channels.

In Example 7, the subject matter of any of Examples 1-6 can optionally include where the processing circuitry is further configured to: encode a physical header of the resource allocation frame, wherein a bandwidth of the physical header is one from the following group: the bandwidth of the one or more channels of the resource allocation or the bandwidth of the plurality of channels that are sensed as not being busy.

In Example 8, the subject matter of any of Examples 1-7 can optionally include where the resource allocation further comprises a multi-user multiple input and multiple output (MU-MIMO) resource allocation, wherein the MU-MIMO resource allocation comprises one or more spatial streams for a station of the one or more stations.

In Example 9, the subject matter of any of Examples 1-8 can optionally include where the processing circuitry is further configured to: decode feedback (FB) from the one or more stations, wherein the FB indicates a status of the one or more stations; and determine the resource allocation for the one or more stations for the DL or UL OFDMA transmission opportunity, wherein the resource allocation comprises one or more sub-channels, wherein the one or more sub-channels are within the plurality of channels that are sensed as not being busy, and wherein the resource allocation is based on the FB from the one or more stations.

In Example 10, the subject matter of Example 9 can optionally include where the FB from the one or more stations indicates one of the following group: one or more preferred channels of the plurality of channels and whether one or more channels of the plurality of channels is busy.

In Example 11, the subject matter of Example 11 can optionally include where the processing circuitry is further configured to: determine a modulation and coding scheme for the one or more sub-channels based on the FB from the one or more stations.

In Example 12, the subject matter of any of Examples 1-11 can optionally include where the wireless device and plurality of stations are each at least one from the following group: a high-efficiency wireless local-area network (HEW) station, an access point, an Institute of Electrical and Electronic Engineers (IEEE) 802.11ax access point, and an IEEE 802.11ax station.

In Example 13, the subject matter of any of Examples 1-12 can optionally include transceiver circuitry coupled to the memory.

In Example 14, the subject matter of Example 13 can optionally include one or more antennas coupled to the transceiver circuitry.

Example 15 is a non-transitory computer-readable storage medium that stores instructions for execution by one or more processors. The instructions configure the one or more processors to cause a wireless device to: configure the access point to sense a plurality of channels of a bandwidth; and determine a resource allocation for one or more stations for an uplink (UL) or downlink (DL) orthogonal frequency division multiple access (OFDMA) transmission opportunity, wherein the resource allocation comprises one or more sub-channels, wherein the one or more sub-channels are within the plurality of channels that are sensed as not being busy.

In Example 16, the subject matter of Example 15 can optionally include where the instructions further configure the one or more processors to cause the wireless device to: configure the access point to sense the one or more channels of the bandwidth in accordance with a clear channel assessment in accordance with Institute of Electrical and Electronic Engineers (IEEE) 802.11.

Example 17 is a method performed by an access point. The method including configuring the access point to sense a plurality of channels of a bandwidth; and determining a resource allocation for one or more stations for an uplink (UL) or downlink (DL) orthogonal frequency division multiple access (OFDMA) transmission opportunity, where the resource allocation comprises one or more sub-channels, wherein the one or more sub-channels are within the plurality of channels that are sensed as not being busy.

In Example 18, the subject matter of Example 17 can optionally include configuring the access point to sense the one or more channels of the bandwidth in accordance with a clear channel assessment in accordance with Institute of Electrical and Electronic Engineers (IEEE) 802.11.

In Example 19 is an apparatus of a station. The apparatus including memory; and processing circuitry coupled to the memory, the processing circuitry may be configured to: decode a trigger frame comprising a resource allocation for the station; determine whether to respond to the trigger frame based on energy levels sensed on one or more channels of a bandwidth; and in response to determining to respond to the trigger frame, encode a frame and configure the station to transmit the frame in accordance with the resource allocation and in accordance with orthogonal frequency division multiple access (OFDMA).

In Example 20, the subject matter of Example 19 can optionally include where the one or more channels are 20 MHz channels or less and the bandwidth is one from the following group: 20 MHz, 40 Mhz, 80 MHz, 160 MHz, and 320 MHz.

In Example 21, the subject matter of Example 20 can optionally include where the resource allocation comprises one or more sub-channels each are one from the following group: a multiple of 2.03 MHz, a multiple of exactly 26 data sub-carriers, and 20 MHz.

In Example 22, the subject matter of any of Examples 19-21 can optionally include where the resource allocation indicates a sub-channel allocated to the station, and wherein the processing circuitry is configured to: determine to respond to the trigger frame if energy levels sensed on the sub-channel are below a threshold for a pre-determined duration.

In Example 23, the subject matter of any of Examples 19-22 can optionally include where the resource allocation indicates a sub-channel allocated to the station, and wherein the processing circuitry is configured to: determine to respond to the trigger frame if first energy levels sensed on the sub-channel are below a first threshold for a pre-determined duration and second energy levels sensed on neighboring sub-channels are below a second threshold for a second predetermined time.

In Example 24, the subject matter of any of Examples 19-23 can optionally include transceiver circuitry coupled to the memory.

In Example 25, the subject matter of Example 24 can optionally include one or more antennas coupled to the transceiver circuitry.

Example 26 is an apparatus of an access point comprising: means for configuring the access point to sense a plurality of channels of a bandwidth: and means for determining a resource allocation for one or more stations for an uplink (UL) or downlink (DL) orthogonal frequency division multiple access (OFDMA) transmission opportunity, wherein the resource allocation comprises one or more sub-channels, wherein the one or more sub-channels are within the plurality of channels that are sensed as not being busy.

In Example 27, the subject matter of Example 26 can optionally include means for encoding a trigger frame comprising the resource allocation to initiate the UL OFDMA transmission opportunity; and means for configuring the access point to transmit the trigger frame to the one or more stations.

In Example 28, the subject matter of Example 26 can optionally include where the one or more channels are 20 MHz channels and the bandwidth is one from the following group: 20 MHz, 40 MHz, 80 MHz, 160 MHz. and 320 MHz.

In Example 29, the subject matter of Example 28 can optionally include where the one or more sub-channels each are one from the following group: a multiple of 2.03 MHz, a multiple of exactly 26 data sub-carriers, and 20 MHz.

In Example 30, the subject matter of any of Examples 26-29 can optionally include means for configuring the access point to sense the one or more channels of the bandwidth in accordance with a clear channel assessment in accordance with Institute of Electrical and Electronic Engineers (IEEE) 802.11.

In Example 31, the subject matter of Example 30 can optionally include means for configuring the access point to sense the one or more channels of the bandwidth with a second bandwidth that is smaller than a third bandwidth of the one or more channels.

In Example 32, the subject matter of any of Examples 26-31 can optionally include means for encoding a physical header of the resource allocation frame, wherein a bandwidth of the physical header is one from the following group: the bandwidth of the one or more channels of the resource allocation or the bandwidth of the plurality of channels that are sensed as not being busy.

In Example 33, the subject matter of any of Examples 26-32 can optionally include where the resource allocation further comprises a multi-user multiple input and multiple output (MU-MIMO) resource allocation, wherein the MU-MIMO resource allocation comprises one or more spatial streams for a station of the one or more stations.

In Example 34, the subject matter of any of Examples 26-33 can optionally include means for decoding feedback (FB) from the one or more stations, wherein the FB indicates a status of the one or more stations; and means for determining the resource allocation for the one or more stations for the DL or UL OFDMA transmission opportunity, wherein the resource allocation comprises one or more sub-channels, wherein the one or more sub-channels are within the plurality of channels that are sensed as not being busy, and wherein the resource allocation is based on the FB from the one or more stations.

In Example 35, the subject matter of Example 34 can optionally include where the FB from the one or more stations indicates one of the following group: one or more preferred channels of the plurality of channels and whether one or more channels of the plurality of channels is busy.

In Example 36, the subject matter of Example 35 can optionally include means for determining a modulation and coding scheme for the one or more sub-channels based on the FB from the one or more stations.

In Example 37, the subject matter of any of Examples 26-36 can optionally include where the wireless device and plurality of stations are each at least one from the following group: a high-efficiency wireless local-area network (HEW) station, an access point, an Institute of Electrical and Electronic Engineers (IEEE) 802.11ax access point, and an IEEE 802.11ax station.

In Example 38, the subject matter of any of Examples 26-37 can optionally include means for performing transceiver functions coupled to means for retrieving and storing information.

In Example 39, the subject matter of Example 38 can optionally include means for transmitting and receiving radio waves.

Example 40 is an apparatus of a station comprising: means for decoding a trigger frame comprising a resource allocation for the station; means for determining whether to respond to the trigger frame based on energy levels sensed on one or more channels of a bandwidth; and in response to determining to respond to the trigger frame, means for encoding a frame and configure the station to transmit the frame in accordance with the resource allocation and in accordance with orthogonal frequency division multiple access (OFDMA).

In Example 41, the subject matter of Example 40 can optionally include where the one or more channels are 20 MHz channels or less and the bandwidth is one from the following group: 20 MHz, 40 Mhz, 80 MHz, 160 MHz. and 320 MHz.

In Example 42, the subject matter of Examples 41 can optionally include where the resource allocation comprises one or more sub-channels each are one from the following group: a multiple of 2.03 MHz, a multiple of exactly 26 data sub-carriers, and 20 MHz.

In Example 43, the subject matter of any of Examples 40-42 can optionally include where the resource allocation indicates a sub-channel allocated to the station, and further comprising: means for determining to respond to the trigger frame if energy levels sensed on the sub-channel are below a threshold for a pre-determined duration.

In Example 4, the subject matter of any of Examples 40-43 can optionally include wherein the resource allocation indicates a sub-channel allocated to the station, and further comprising: means for determining to respond to the trigger frame if first energy levels sensed on the sub-channel are below a first threshold for a pre-determined duration and second energy levels sensed on neighboring sub-channels are below a second threshold for a second predetermined time.

In Example 45, the subject matter of any of Examples 26-37 can optionally include means for performing transceiver functions coupled to means for retrieving and storing information.

In Example 46, the subject matter of any of Examples 26-37 can optionally include means for transmitting and receiving radio waves.

Example 47 is a method performed by a station. The method may include decoding a trigger frame comprising a resource allocation for the station; determining whether to respond to the trigger frame based on energy levels sensed on one or more channels of a bandwidth; and in response to determining to respond to the trigger frame, encoding a frame and configure the station to transmit the frame in accordance with the resource allocation and in accordance with orthogonal frequency division multiple access (OFDMA).

In Example 48, the subject matter of Example 47 can optionally include wherein the one or more channels are 20 MHz channels or less and the bandwidth is one from the following group: 20 MHz, 40 Mhz, 80 MHz, 160 MHz, and 320 MHz.

In Example 49, the subject matter of Example 48 can optionally include wherein the resource allocation comprises one or more sub-channels each are one from the following group: a multiple of 2.03 MHz, a multiple of exactly 26 data sub-carriers, and 20 MHz.

In Example 50, the subject matter of any of Examples 47-49 can optionally include wherein the resource allocation indicates a sub-channel allocated to the station, and further comprising: determining to respond to the trigger frame if energy levels sensed on the sub-channel are below a threshold for a pre-determined duration.

In Example 51, the subject matter of any of Examples 47-50 can optionally include wherein the resource allocation indicates a sub-channel allocated to the station, and further comprising: determining to respond to the trigger frame if first energy levels sensed on the sub-channel are below a first threshold for a pre-determined duration and second energy levels sensed on neighboring sub-channels are below a second threshold for a second predetermined time.

In Example 52, the subject matter of any of Examples 47-51 can optionally include performing transceiver functions coupled to means for retrieving and storing information.

In Example 53, the subject matter of Example 52 can optionally include transmitting and receiving radio waves.

Example 54 is a non-transitory computer-readable storage medium that stores instructions for execution by one or more processors. The instructions are to configure the one or more processors to cause a wireless device to: decode a trigger frame comprising a resource allocation for the station; determine whether to respond to the trigger frame based on energy levels sensed on one or more channels of a bandwidth; and in response to determining to respond to the trigger frame, encode a frame and configure the station to transmit the frame in accordance with the resource allocation and in accordance with orthogonal frequency division multiple access (OFDMA).

In Example 55, the subject matter of Examples 54 can optionally include wherein the one or more channels are 20 MHz channels or less and the bandwidth is one from the following group: 20 MHz, 40 Mhz, 80 MHz, 160 MHz, and 320 MHz.

In Example 56, the subject matter of Examples 54 can optionally include wherein the resource allocation comprises one or more sub-channels each are one from the following group: a multiple of 2.03 MHz, a multiple of exactly 26 data sub-carriers, and 20 MHz.

In Example 57, the subject matter of any of Examples 54-56 can optionally include wherein the resource allocation indicates a sub-channel allocated to the station, and wherein the instructions further configure the one or more processors to cause the wireless device to: determine to respond to the trigger frame if energy levels sensed on the sub-channel are below a threshold for a pre-determined duration.

In Example 58, the subject matter of any of Examples 54-57 can optionally include wherein the resource allocation indicates a sub-channel allocated to the station, and wherein the instructions further configure the one or more processors to cause the wireless device to: determine to respond to the trigger frame if first energy levels sensed on the sub-channel are below a first threshold for a pre-determined duration and second energy levels sensed on neighboring sub-channels are below a second threshold for a second predetermined time.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus of an access point, the apparatus comprising memory; and processing circuitry coupled to the memory, the processing circuitry configured to:
configure the access point to sense a plurality of channels of a bandwidth; and
determine a resource allocation for one or more stations for an uplink (UL) or downlink (DL) orthogonal frequency division multiple access (OFDMA) transmission opportunity, wherein the resource allocation comprises one or more sub-channels, wherein the one or more sub-channels are within the plurality of channels that are sensed as not being busy.

2. The apparatus of claim 1, wherein the processing circuitry is further configured to:
encode a trigger frame comprising the resource allocation to initiate the UL OFDMA transmission opportunity; and
configure the access point to transmit the trigger frame to the one or more stations.

3. The apparatus of claim 1, wherein the one or more channels are 20 MHz channels and the bandwidth is one from the following group: 20 MHz, 40 MHz, 80 MHz, 160 MHz, and 320 MHz.

4. The apparatus of claim 3, wherein the one or more sub-channels each are one from the following group: a multiple of 2.03 MHz, a multiple of exactly 26 data sub-carriers, and 20 MHz.

5. The apparatus of any of claim 1, wherein the processing circuitry is further configured to:
configure the access point to sense the one or more channels of the bandwidth in accordance with a clear channel assessment in accordance with Institute of Electrical and Electronic Engineers (IEEE) 802.11.

6. The apparatus of claim 5, wherein the processing circuitry is further configured to:
configure the access point to sense the one or more channels of the bandwidth with a second bandwidth that is smaller than a third bandwidth of the one or more channels.

7. The apparatus of any of claim 1, wherein the processing circuitry is further configured to:
encode a physical header of the resource allocation frame, wherein a bandwidth of the physical header is one from the following group: the bandwidth of the one or more channels of the resource allocation or the bandwidth of the plurality of channels that are sensed as not being busy.

8. The apparatus of any of claim 1, wherein the resource allocation further comprises a multi-user multiple input and multiple output (MU-MIMO) resource allocation, wherein the MU-MIMO resource allocation comprises one or more spatial streams for a station of the one or more stations.

9. The apparatus of any of claim 1, wherein the processing circuitry is further configured to:
decode feedback (FB) from the one or more stations, wherein the FB indicates a status of the one or more stations; and
determine the resource allocation for the one or more stations for the DL or UL OFDMA transmission opportunity, wherein the resource allocation comprises one or more sub-channels, wherein the one or more sub-channels are within the plurality of channels that are sensed as not being busy, and wherein the resource allocation is based on the FB from the one or more stations.

10. The apparatus of claim 9, wherein the FB from the one or more stations indicates one of the following group: one or more preferred channels of the plurality of channels and whether one or more channels of the plurality of channels is busy.

11. The apparatus of claim 9, wherein the processing circuitry is further configured to:
determine a modulation and coding scheme for the one or more sub-channels based on the FB from the one or more stations.

12. The apparatus of any of claim 1, wherein the wireless device and plurality of stations are each at least one from the following group: a high-efficiency wireless local-area network (HEW) station, an access point, an Institute of Electrical and Electronic Engineers (IEEE) 802.11ax access point, and an IEEE 802.11ax station.

13. The apparatus of any of claim 1, further comprising transceiver circuitry coupled to the memory.

14. The apparatus of claim 13, further comprising one or more antennas coupled to the transceiver circuitry.

15. A non-transitory computer-readable storage medium that stores instructions for execution by one or more processors, the instructions to configure the one or more processors to cause a wireless device to:
configure the access point to sense a plurality of channels of a bandwidth; and
determine a resource allocation for one or more stations for an uplink (UL) or downlink (DL) orthogonal frequency division multiple access (OFDMA) transmission opportunity, wherein the resource allocation comprises one or more sub-channels, wherein the one or more sub-channels are within the plurality of channels that are sensed as not being busy.

16. The non-transitory computer-readable storage medium of claim 15, wherein the instructions further configure the one or more processors to cause the wireless device to:
configure the access point to sense the one or more channels of the bandwidth in accordance with a clear channel assessment in accordance with Institute of Electrical and Electronic Engineers (IEEE) 802.11.

17. A method performed on an access point, the method comprising:
configuring the access point to sense a plurality of channels of a bandwidth; and
determining a resource allocation for one or more stations for an uplink (UL) or downlink (DL) orthogonal frequency division multiple access (OFDMA) transmission opportunity, wherein the resource allocation comprises one or more sub-channels, wherein the one or more sub-channels are within the plurality of channels that are sensed as not being busy.

18. The method of claim 17, the method further comprising:
configuring the access point to sense the one or more channels of the bandwidth in accordance with a clear channel assessment in accordance with Institute of Electrical and Electronic Engineers (IEEE) 802.11.

19. An apparatus of a station, the apparatus comprising memory; and processing circuitry coupled to the memory, the processing circuitry configured to:
decode a trigger frame comprising a resource allocation for the station;
determine whether to respond to the trigger frame based on energy levels sensed on one or more channels of a bandwidth; and
in response to determining to respond to the trigger frame, encode a frame and configure the station to transmit the frame in accordance with the resource allocation and in accordance with orthogonal frequency division multiple access (OFDMA).

20. The apparatus of claim 19, wherein the one or more channels are 20 MHz channels or less and the bandwidth is one from the following group: 20 MHz, 40 Mhz, 80 MHz, 160 MHz, and 320 MHz.

21. The apparatus of claim 20, wherein the resource allocation comprises one or more sub-channels each are one from the following group: a multiple of 2.03 MHz, a multiple of exactly 26 data sub-carriers, and 20 MHz.

22. The apparatus of claim 19, wherein the resource allocation indicates a sub-channel allocated to the station, and wherein the processing circuitry is configured to:
determine to respond to the trigger frame if energy levels sensed on the sub-channel are below a threshold for a pre-determined duration.

23. The apparatus of claim 19, wherein the resource allocation indicates a sub-channel allocated to the station, and wherein the processing circuitry is configured to:
determine to respond to the trigger frame if first energy levels sensed on the sub-channel are below a first threshold for a pre-determined duration and second energy levels sensed on neighboring sub-channels are below a second threshold for a second predetermined time.

24. The apparatus of claim 19, further comprising transceiver circuitry coupled to the memory.

25. The apparatus of claim 24, further comprising one or more antennas coupled to the transceiver circuitry.
